(19) United States
(12) Patent Application Publication
(10) Pub. No.: US 2005/0178850 A1
(43) Pub. Date: Aug. 18, 2005

(54) Static absorbing grip

(76) Inventor: Ray Allen Lumsden, Cedartown, GA (US)

Correspondence Address: Ray Allen Lumsden, 2839 Rome Highway, Cedartown, GA, 30125-4415, US

(21) Appl. No.: 10/781,435

(22) Filed: Feb. 17, 2004

(51) Int. Cl. B05B 1/28

(52) U.S. Cl. 239/103

(57) ABSTRACT

Disclosed is a static absorbing grip which removes static electricity by means of absorbing and depleting the static charge. This device is designed and intended primarily for use with petroleum dispensing devices commonly known as fuel or gas nozzles. Static electricity is actually eliminated in a “bleed off” or “bleed down” process which is performed without sparking or arching, usually associated with static electricity by contact or release. This device is formed to fit the handle area of fuel dispensing nozzles. It may be applied to bare metal or over protective rubber covers. This device is easily attached or removed without disconnecting the nozzle from the supply hose.

### BACKGROUND OF THE INVENTION

The present invention of the static absorbing grip device is to provide a safe and effective means of eliminating static electricity without dangers of static arching or sparking.

There have been developed other devices for dealing with problems relating to static electricity and the dangers associated in the use of fuel dispensing equipment, primarily the fuel nozzle. The devices have for the most part, dealt with providing a covering for fuel nozzles in an effort to insulate the metal from sparks or arcs from static electricity. While these devices may provide some protection, static arcs and sparks may still occur.

### SUMMARY OF INVENTION

A primary objective of present invention is to provide an efficient means to absorb and totally eliminate any static charge from the person in contact with fuel nozzle being therefore exposed to fuel and fumes.

Another objective of the present invention is to provide an device which can be easily produced and done so at a cost effective means which will make this device practical for implementation to provide added protection and security for users of this device. To achieve the above and additional considerations, the present invention uses a readily available static absorbing material which has been in use for several years, and has been proven to be effective in absorbing and depleting static electricity without static arcing or sparks. This material reacts much like a sponge absorbs water in that it absorbs in minute amounts of static electricity far below the levels of 40 to 95 volts with is normally necessary for sparking and arcing. This static absorbing material is very durable and is used in the manufacturing of static absorbing shoe covers, work aprons, gloves, pods “individual finger covers” to name a few. It is also found in use a workbench covers where static arcs and sparks could damage or destroy highly sensitive electronic parts.

The use of conductive adhesive component provides a secure ground for the device and provides a route for any residual static charge to be further absorbed and dispersed into the mass of the handle of the fuel nozzle. The use of semicircular tube secured to material along top section of device provides added stability and helps prevent twisting and pulling loose of material.

### BRIEF DESCRIPTION OF DRAWINGS

The above and other objects of the invention can best be understood by examining the detailed description of the preferred embodiments and accompanying drawings wherein.

FIG. 1 depicts each individual part making up the present invention, each shown in an unattached state. Parts consist of part 1, static absorbing material; part 2, plastic form; part 3, two-sided adhesive tape; part 4, two-sided adhesive conductive tape; and part 5, one-sided adhesive tape.

FIG. 2 depicts present invention in assembled stage.

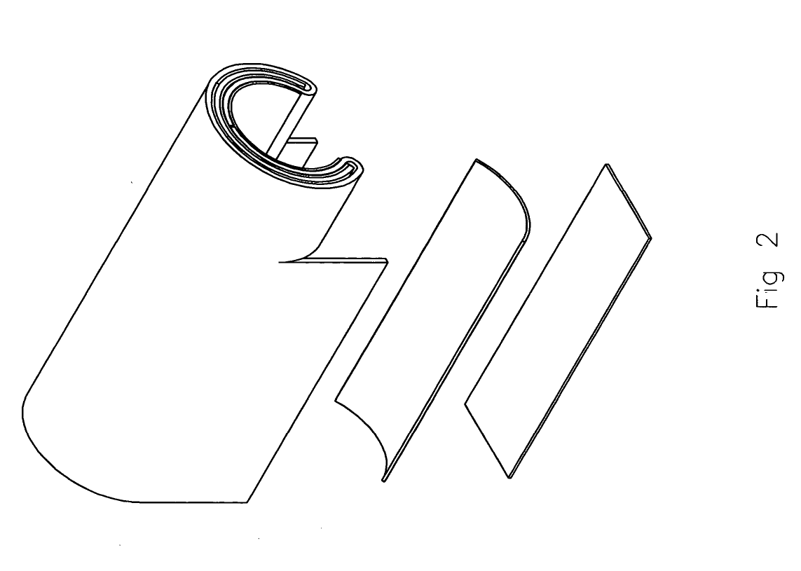

FIG. 3 depicts present invention as it will appear when attached to fuel nozzle and ready for use.

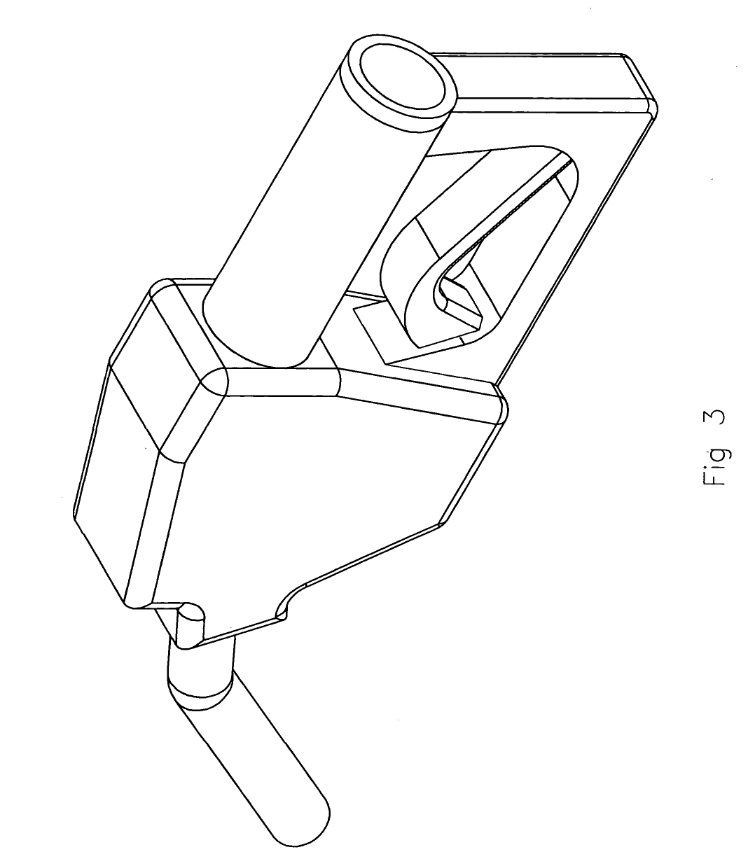

### DETAILED DESCRIPTION OF THE PREFERRED EMBODIMENT

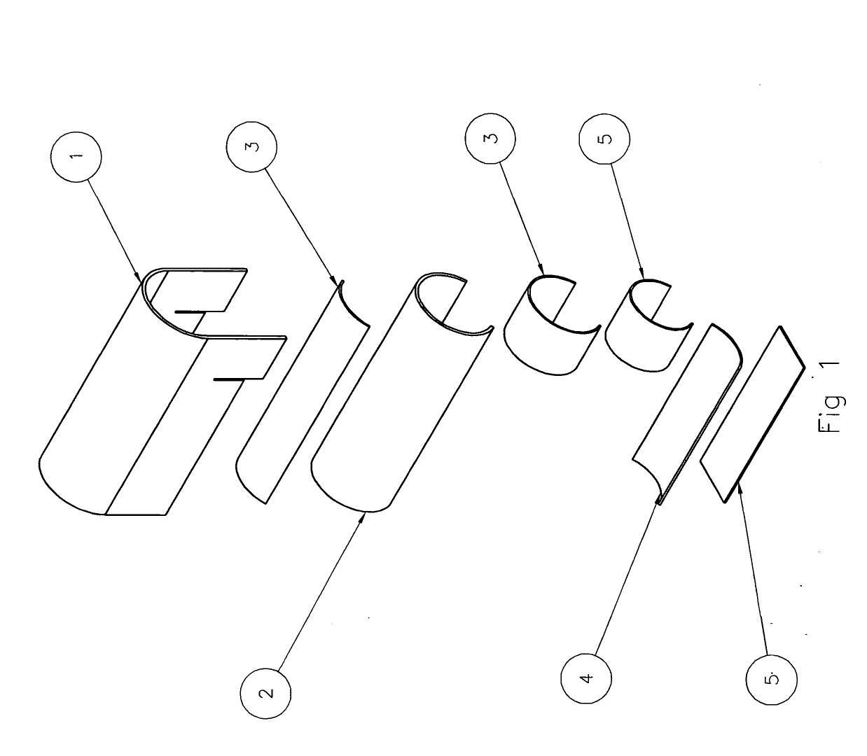

Please refer to FIG. 1 of drawings. The present invention includes (part 1) static absorbing material. This material is readily available from various manufacturers and is produced in sheet form. It also may be manufactured in a compound form and be mold formed and be applied to objects or material. This static absorbing material is effective in eliminating static electricity without the occurrence of arcs or sparks. Part 1 is formed to cover the handle portion of fuel dispensing nozzles and may be applied by securing two-sided conduction tape (part 5 as shown in drawing FIG. 1). The conductive tape is also readily available from various anti-static product manufacturers. This conductive tape is applied to the clean and dry bare metal located on underside of nozzle handle. Static absorbing material (part 1) is secured to approximately one half of exposed adhesion side of conduction tape. Remaining portion of material is pulled over top section of fuel nozzle with molded plastic form (part 2 in FIG. 1 drawing) being centered at top of nozzle handle. This provides stability of form and helps eliminate any twisting or pulling of material which may result in loosening of secured joints of material. It is shown being attached to part 1 by means of use of two-sided tape (part 3). This bond may also be achieved by using an adhesive compound being applied to top portion of part 2 and to the rear bottom of part 2 where static absorbing material is secured underneath. Remaining portion of material (part 1) is adhered to the remaining section of conductive tape on underside of nozzle handle. This completes the total enclosure of nozzle handle area. One-sided adhesive vinyl or plastic type tape; (shown as part 5 in FIG. 1 drawing) is a common type of tape which in this application serves to protect static absorbing material at locations where material is joined together. Another purpose for this tape is to aid in prevention of pulling apart of material. This tape is readily accessible and available from many manufacturers.

The present invention provides for the safe and complete removal of static electricity which may be present in or on the body of the user of fueling devices. This static build up can result from many causes, a few being: friction between clothing being worn, static build up from sliding across vehicle seat, use of shoes which have soles that fail to provide grounding source, possible use of cell phones during fueling procedures.

With the advent of more and more self serve fueling stations, the use of present invention making use of the proven ability of static absorbing material insures a much safer fueling procedure as compared with other devices which are intended and directed at insulating one from the occurrence of static arcs and sparks.

1. A static absorbing material formed in a manner to conform to the shape of the handle are of fuel dispensing nozzles.

2. The static absorbing device claimed in claim 1, wherein material is bound together by a section of two-sided conductive material resulting in a secured and grounded object.

3. The static absorbing device claimed in claim 1, wherein material is bound together by a section of either two-sided adhesive strip or by an adhesive compound to a semicircular tube form extending entire length of handle section of fuel nozzle.

4. The static absorbing device claimed in claim 1, wherein a one-sided adhesive strip is secured over each area where static eliminating material is joined together providing extra adhesion and protection to joined material.
